(19) United States
(12) Patent Application Publication
(10) Pub. No.: US 2008/0314915 A1
(43) Pub. Date: Dec. 25, 2008

(54) Tank for Oils or Liquids for Direct Fastening on a Fastening Surface

(76) Inventors: Keit Wagener, Bissendorf (DE); Peter Lindeckert, Stuttgart (DE)

Correspondence Address: MCGLEW & TUTTLE, PC, P.O. BOX 9227, SCARBOROUGH STATION, SCARBOROUGH, NY, 10510-9227, US

(21) Appl. No.: 10/597,158

(22) PCT Filed: Jan. 14, 2005
(86) PCT No.: PCT/DE2005/000052

§ 371 Date: Sep. 8, 2008

(30) Foreign Application Priority Data
Jan. 14, 2004 (DE) 10 2004 002 108.2

(51) Int. Cl. B60K 15/00

(52) U.S. Cl. 220/746

(57) ABSTRACT

A tank for oils or liquids designed for being fastened directly on a fastening surface. The tank can be fastened in a compact manner and with reliable hold on a fastening surface while having a sufficient tank volume. At least one fastener acting directly on the fastening surface is led through the tank volume.

### CROSS REFERENCE TO RELATED APPLICATIONS

This application is a United States National Phase application of International Application PCT/DE 2005/000052 and claims the benefit of priority under 35 U.S.C. § 119 of German Patent Application DE 10 2004 002 108.2 filed Jan. 14, 2004, the entire contents of which are incorporated herein by reference.

### FIELD OF THE INVENTION

The present invention pertains to a tank for oils or liquids designed for direct fastening on a fastening surface. Corresponding to an embodiment, it pertains specifically to an oil tank for fastening on a vehicle, preferably on a motor vehicle engine.

### BACKGROUND OF THE INVENTION

Aside from the fuel tank, tanks for oils and/or liquids are installed at different locations in motor vehicles. The tanks are needed, for example, as an oil reservoir, in order to ensure a predetermined circulation volume for the oil in an oil circulation. They are used as oil tanks, among other things, in connection with the oil circulation of a power steering or even in connection with the lubrication and cooling of a motor vehicle engine. In the latter case, they are also used to ensure that the oil used to cool the engine has a sufficient residence time away from the engine in order to release the heat to be removed by it into the environment. It is only in this way that the oil itself can cool again and assume its cooling function as a result.

Corresponding tanks, i.e., oil tanks, are fastened to the respective fastening surface according to the state of the art by means of tightening straps, a positive-locking connection with a sheet metal holder, by means of dowel pins or by screwing on directly. Openings for the screws are provided on the circumference of the tank for fastening by means of screws. The tank is either provided for this purpose with a circular collar, on which holes are provided for the screws at spaced locations, or a plurality of eyelets are arranged on the circumference of the tank. A tank of this class is disclosed, for example, in DE 100 37 856 A1. The document pertains to an oil tank for optimizing the oil balance of an internal combustion engine or a transmission as well as to a process for manufacturing same. A plurality of eyelets for screws used to fasten the tank are arranged on the circumferential surface on the tank described.

However, there is a problem, especially in automotive engineering, due to the fact that a very limited space is frequently available for the components to be mounted. This prior art procedure for forming tanks with a possibility of fastening has not therefore proved to be very compact.

### SUMMARY OF THE INVENTION

The object of the present invention is therefore to design a tank for accommodating oils or liquids such that while having a sufficient tank volume, it can be mounted on a fastening surface in a compact manner and with reliable hold. Simple mounting, especially in poorly accessible areas, is to be supported, in particular, due to the corresponding design embodiment.

The tank for oils or liquids according to the present invention is fastened by means of fastening means acting directly on the intended fastening surface. According to the present invention, at least one of the fastening means acting directly on the fastening surface is passed through the volume of the tank. The volume, which is available for the fluid to be accommodated by the tank, is not appreciably reduced hereby, but a shape that is very compact toward the outside and can therefore be installed in a compact manner can at the same time be obtained for the tank.

Corresponding to an embodiment of the present invention, which is relevant for practice, the tank designed in the manner described is an oil tank for being fastened on a motor vehicle, preferably on the motor vehicle engine, the tank having at least one screw connection led through the volume of the tank.

Even if the tank is optionally intended for mounting on the motor vehicle engine, it does not necessarily have to be a tank for the motor oil. Rather, it is also conceivable, for example, to fasten an oil tank designed according to the present invention for the power steering on the motor vehicle engine.

According to an especially preferred embodiment, the tank is to be fastened to the fastening surface by means of screws, which are led through ducts arranged at and/or in the tank. According to the present invention, at least one of the ducts for the screws passes through the tank volume, so that the tank can be fastened in a compact manner and reliably due to the optionally central arrangement of the corresponding duct with the screw led through the channel. The fastening is brought about either by means of self-furrowing or self-cutting screws, which mesh with corresponding holes in the area of the fastening surface or screws that are screwed into precut threads.

According to a possible embodiment, the tank comprises a shell-like tank part and a tank cover welded thereto and includes a filler neck for introducing the fluid in question as well as two connection pipes for integrating the tank in an oil or liquid circulation. The tank is fastened by means of at least one screw led through the tank in a duct and additional screws led through ducts on the outer circumference of the shell-like tank part. The ducts arranged on the circumference of the shell-like tank part are advantageously shortened compared to the depth of this tank part. At the same time, recesses, through which a tool can pass but the head of a screw used to fasten the tank cannot, are provided on the circumference of the tank cover, in the area of the ducts. A means ensuring captive holding, which prevents the screws introduced into the ducts from sliding out inadvertently, is thus formed. The ducts arranged on the circumference of the shell-like part of the tank are preferably shortened compared to their depth in this embodiment of the tank according to the present invention to the extent that a free space, which facilitates the mounting of the tank on the fastening surface by the screws used for fastening being able to be moved in the free space when the tank is attached to the fastening surface, is obtained between these ducts and the welded-on tank cover.

According to an especially preferred embodiment, the screws, which will later be used to fasten the tank, are premounted on the tank on the tank side already in the course of the manufacture of the tank. In conjunction with the already mentioned captive holding of the screws, significant simplification of assembly is thus achieved during the fastening of the tank at the site intended therefor, for example, in a poorly accessible area of a motor vehicle.

The passage of fastening means through the tank in the corresponding positions does, of course, require sealing. Sealing can be achieved by means of a weld seam, for example, in the case of a duct for a screw. It is advantageously possible now to prepare this weld seam, while avoiding additional operations, in conjunction with the welding of tank parts, i.e., of a shell-like tank part, to the tank cover.

According to another advantageous variant, positioning aids may be provided on the outer surface of the tank, which is to be brought into contact with the fastening surface, in the area of the passage of the ducts for the screws. The assembly of the tank and its fastening are further simplified hereby.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a front view of the tank according to the present invention;

FIG. 2 is a three-dimensional view of the tank according to FIG. 1;

FIG. 3 is a side view showing the tank in the view toward the outer surface to be brought into contact with the fastening surface; and

FIG. 4 is a top view of the tank.

FIG. 5 is three-dimensional sectional view of the tank.

### DESCRIPTION OF THE PREFERRED EMBODIMENTS

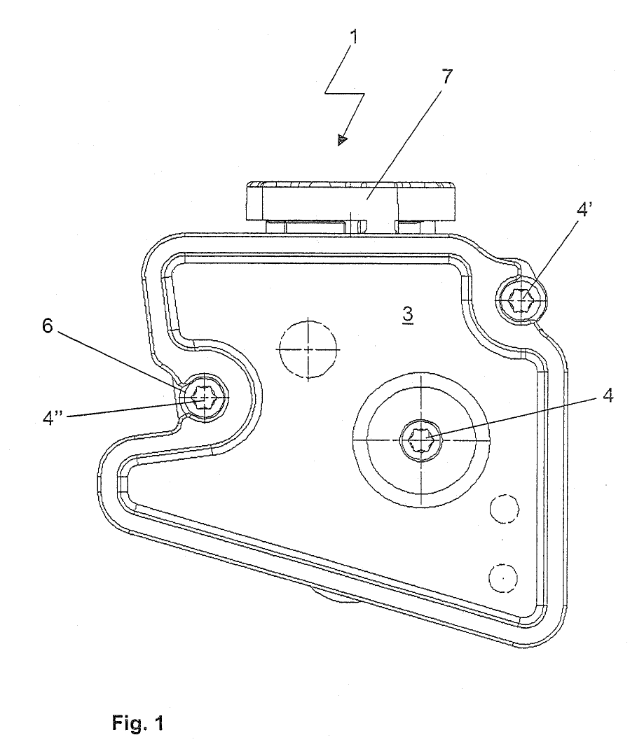

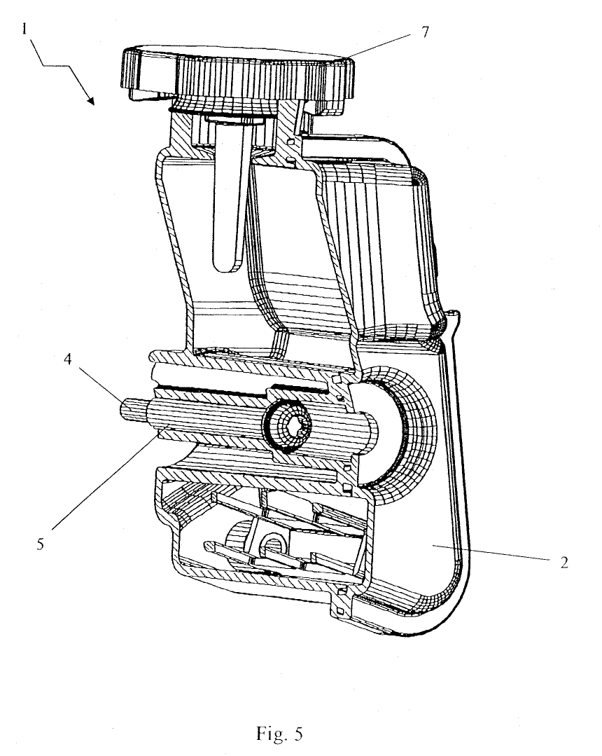

Referring to the drawings in particular, FIG. 1 shows a front view of the tank 1 according to the present invention. The tank 1 shown as an example is an oil tank for a power steering to be fastened to a motor vehicle engine. The tank 1 can be mounted on the motor vehicle engine, not shown here, by means of three screws 4, 4′, 4″ at three points. According As best seen in FIG. 5, according to the basic idea of the present invention, a screw connection is led through the tank volume, the screw 4 being used being led through a duct 5 extending through the tank 1. Two other screws 4′, 4″ act directly on the fastening surface and on a surface of the motor vehicle engine, respectively, via ducts 5 arranged on the circumference of the tank 1. As can be recognized, recesses 6, via which, for example, an electric or pneumatic screwdriver can be attached to the screws 4′, 4″ during the mounting of the tank 1, are provided in the area of these two screws 4′, 4″ on the circumference of the tank cover 3 closing the tank 1. The recesses 6 are dimensioned such that even though the tool can pass through them, the heads of the screws 4′, 4″ cannot. A means ensuring captive holding, which makes it possible to premount the screws 4′, 4″ on the tank already in the course of the manufacture of the tank 1, is thus formed by the tank cover 3 designed in this manner.

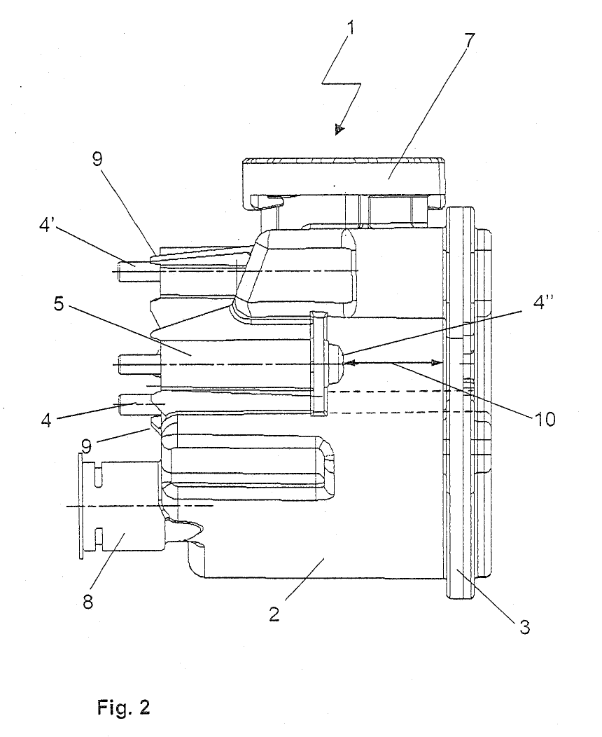

As is better illustrated in FIG. 2, the tank 1 comprises a shell-like tank part 2, to which the tank cover 3, visible in the front view according to FIG. 1, is welded. The screw connection (with the screw 4) led through the tank volume is sealed at the same time by a weld seam against the escape of oil from the tank 1 in the course of welding. Thus, even though the design of the tank 1 with a screw connection passed through the tank volume does require the preparation of an additional weld seam for sealing same, this does not raise the need for any further operation, which is favorable in terms of the manufacturing technology, because, as was already explained, the corresponding weld seam is prepared, for example, by vibration welding in conjunction with the welding of the tank parts 2, 3, which is necessary anyway.

The advantage achieved due to the design of the tank 1 according to the present invention becomes very clear from FIG. 1. As can be recognized, the tank 1 can be installed and fastened to the motor vehicle engine in an especially compact manner. It is not necessary to provide a fold or eyelets extending around the circumference of the tank for passing through screws 4, 4′, 4″, nor are additional parts, such as tightening straps and dowel pins, used to fasten the tank 1. Yet, and despite the fact that the screwing points are located close to one another as a result, reliable and stable connection of the tank 1 with the particular fastening surface is achieved.

FIG. 2 shows the exemplary embodiment explained before in a three-dimensional or perspective view. The two-part design of the tank 1 with the shell-like tank part 2 and the tank cover 3 welded thereto can be recognized here. As can be seen, the tank 1 has a filler neck 7 for filling in the oil and two connection pipes 8, 8′ for integration in an oil circulation. In addition, one of the ducts 5, through which a screw 4 of the three screws 4, 4′, 4″ in the example is led for the later fastening of the tank 1 can be recognized. The screws 4, 4′, 4″ are preferably premounted already at the time of the manufacture of the tank. Due to the special design of the tank cover, which was already explained, and the resulting captive holding, the screws 4, 4′, 4″ are prevented from sliding out of the ducts 5. A significant simplification results for the installer, who installs the tank 1, due to the premounting of the screws 4, 4′, 4″. An installer does not need to perform any premounting and can guide a screwdriver used to fasten the tank 1 without problems with the free hand. Changing the grip several times, which is cumbersome, is avoided. In addition, FIG. 2 shows the positioning aids 9, which facilitate reliable positioning of the tank 1 on the fastening surface for the installer or worker.

As is also apparent from FIG. 2, the ducts 5 arranged on the circumference of the tank for the screws 4′, 4″ are shortened in relation to the depth of the shell-like part 2 of the tank to the extent that a sufficient free space 10 is created hereby for handling and moving the screws 4′, 4″. As a result, when bringing the tank 1 into contact with a fastening surface, the installer is not forced to position all screws 4, 4′, 4″ simultaneously in the holes or threads provided, because screws 4, 4′ that at first meet the fastening surface next to the hole or the thread are able to slide back into this free space 10. By contrast, the screws 4′, 4″ are prevented from falling out completely by the means ensuring captive holding, which was already explained. If the free space 10 has a corresponding length, the screws 4′, 4″ may optionally also be introduced laterally into the corresponding duct 5 by tilting unless they were already premounted at the time of the manufacture of the tank, but there is no longer any reliable captive holding in this case.

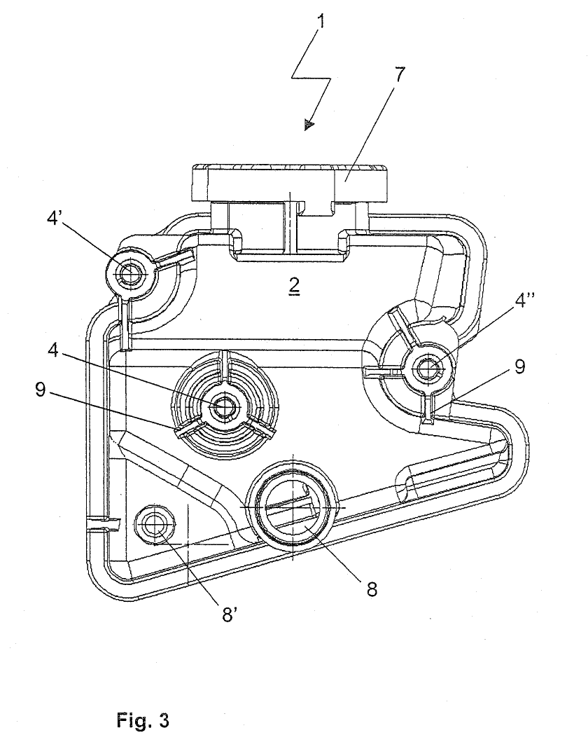

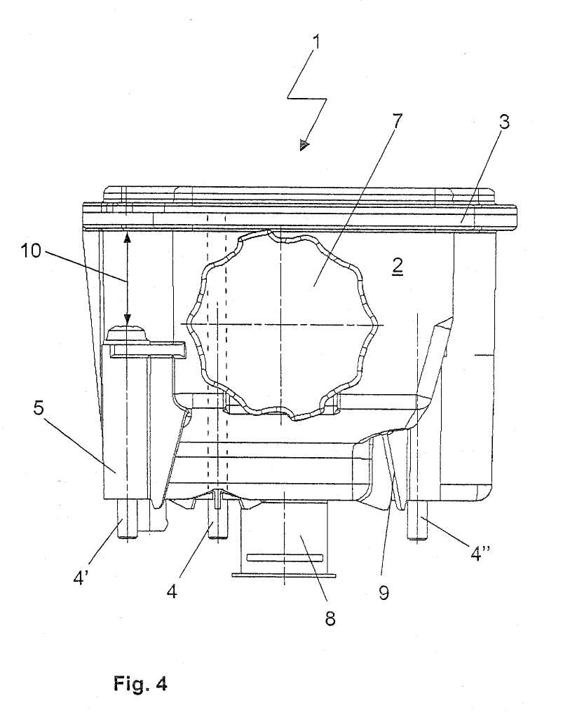

FIG. 3 shows the tank 1 described once again with a view toward its outer side, which will later be brought into contact with the fastening side. The screw 4, which is led through the tank volume and exits through this surface, can be clearly recognized here. Furthermore, the connection pipe 8, 8′ and the positioning aids 9 can be recognized. Finally, FIG. 4 shows a top view of the tank 1. The free space 10 created for the screws 4′, 4″ by the shortening of the ducts 5 can be easily recognized once again in this view. Finally, FIG. 5 shows a three-dimensional section view of the tank 1. FIG. 5 shows the screw 4, which is led through duct 5, extending through the tank 1.

While specific embodiments of the invention have been shown and described in detail to illustrate the application of the principles of the invention, it will be understood that the invention may be embodied otherwise without departing from such principles.

1. A tank for oils or liquids, the tank comprising:
a tank part having a tank volume; and
a fastening means for fastening on a fastening surface, whereby at least one said fastening means passes through the tank volume in a liquid-proof manner.

2. A tank in accordance with claim 1, wherein said one or more fastening means comprises one or more screw connections passing through said tank volume.

3. A tank in accordance with claim 1, further comprising:
one or more first ducts extending within said tank part;
one or more second ducts arranged on an outer circumference of said tank part; and
screws passing through said first ducts and second ducts.

4. A tank in accordance with claim 1, wherein said tank part has a tank cover and a filler neck and two connection pipes, said fastening means comprising one or more first screws passing through one or more first ducts extending through said tank volume and a plurality of second screws passing through one or more second ducts arranged on an outer circumference of said tank part, wherein the second ducts are shortened in relation to the depth of the tank part, and recesses are provided on a circumference of the tank cover in the area of the second ducts.

5. A tank in accordance with claim 4, wherein said second ducts are shortened in relation to the depth of the tank part creating a space defined between said second ducts and the tank cover.

6. A tank in accordance with claim 4,
wherein said first screws and said second screws are premounted on the tank part.

7. A tank in accordance with claim 4, wherein said first screws are sealed by a weld seam.

8. A tank in accordance with claim 4, further comprising one positioning aid for said first and second screws, said positioning aid located on an outer surface of the tank part, in an area of first or second ducts.

9. A tank for holding oils or liquids, said tank comprising:
a tank part having a tank volume; and
a connection means for connecting on a fastening surface, whereby said connection means passes into and out of said tank volume in a leak proof manner.

10. A tank in accordance with claim 9, wherein said tank part includes a tank base, a filler neck and a tank cover, recesses are provided in an area of said connection means on a circumference of said tank cover, two connection pipes, and positioning guides located on an outer surface of said tank part in an area of said connection means.

11. A tank in accordance with claim 9, wherein said connection means comprises screws.

12. A tank in accordance with claim 11, wherein said screws are pre-mounted on said tank part.

13. A tank in accordance with claim 9, wherein said connection means is sealed by a weld seam.

14. A tank in accordance with claim 9, further comprising:
one or more mounting ducts arranged on an outer circumference of said tank part, whereby one or more mounting ducts are of a length less than a depth of said tank part defining a space between said one or more mounting ducts and said tank part; and
another connection means for fastening on a fastening surface, whereby said another connection means passes through said one or more mounting ducts.

15. A fluid tank comprising:
a tank structure having a tank volume; and
a means for actuating and fastening on a fastening surface, said means for actuating and fastening having a fastening actuator on an actuating side, a fastener on a fastener side for engaging the fastening surface and passing from said actuating side of said tank part to said fastening side of said tank part, wherein said fastening side is opposite said actuating side.

16. A tank in accordance with claim 15, wherein:
said tank structure includes a tank base, a filler neck and a tank cover, recesses are provided in an area of said means for actuating and fastening on a circumference of said tank cover, two connection pipes and positioning guides located on an outer surface of said tank part in an area of said connection means.

17. A tank in accordance with claim 9, wherein said means for actuating and fastening comprises screws.

18. A tank in accordance with claim 11, wherein said screws are pre-mounted on said tank part.

19. A tank in accordance with claim 9, wherein said means for actuating and fastening is sealed by a weld seam.

20. A tank in accordance with claim 9, further comprising:
one or more mounting ducts arranged on an outer circumference of said tank part, said ducts having a length less than a depth of said tank part defining a space between said one or more mounting ducts and said tank part; and
another connection means for fastening on a fastening surface, whereby said another connection means passes through said one or more mounting ducts.
